(19) United States
(12) Patent Application Publication
(10) Pub. No.: US 2011/0064855 A1
(43) Pub. Date: Mar. 17, 2011

(54) CHECKERBOARD BAKING PAN SYSTEM AND METHOD

(76) Inventor: Mark Levie, Ross, CA (US)

(21) Appl. No.: 12/879,270

(22) Filed: Sep. 10, 2010

Related U.S. Application Data
(60) Provisional application No. 61/242,048, filed on Sep. 14, 2009.

(51) Int. Cl. A21D 13/08; B22C 9/20

(52) U.S. Cl. 426/275; 426/549; 249/60

(57) ABSTRACT

A checkerboard baking pan system includes at least one pan and an insert for seating inside the at least one pan. The pan has a substantially flat bottom wall and upstanding side walls surrounding the bottom wall to form a receptacle. The pan has a non-circular shape, with said non-circular shape having a length and a width. The insert has at least two longitudinally extending members and at least two cross-braces for coupling the longitudinally extending members together. A method for forming a non-circular checkerboard cake having multi-layers is also discussed and includes forming two or three layers having varying colors using the insert.

### CROSS-REFERENCE TO RELATED APPLICATION

This application claims priority to U.S. Provisional Patent Application No. 61/242,048, filed Sep. 14, 2009, the disclosure of which is incorporated herein by reference in its entirety.

### FIELD

The technology described herein relates to a baking pan having an insert for making a checkerboard cake.

### BACKGROUND

Round checkerboard cake pan systems are known. They are typically made in two or three layers and when cake slices are cut from the cake, a checkerboard pattern is visible in the cake batter. Round systems include two or three round cake pans and an insert that is seated in each cake pan. The insert includes at least two round inner walls that are separated by braces. There are presently no known rectangular checkerboard cake pan systems that allow a user to bake a cake in a checkerboard pattern. However, it was previously known to cut a rectangular cake into sections once the cake has been baked and then position alternating sections adjacent one another to form a checkerboard pattern. This is labor intensive and the resulting cake is unstable due to the various cuts in the cake, which must be glued together with frosting.

### SUMMARY

In accordance with the teachings described herein, a non-circular checkerboard baking pan system is described.

### BRIEF DESCRIPTION OF THE DRAWING FIGURES

FIG. 1 depicts a perspective view of an example baking pan system, shown in an exploded view;

FIG. 2 depicts the example baking pan system of FIG. 1 with an insert seated within a baking pan; and

FIG. 3 depicts a finished triple layer cake that may be formed from the example baking pan system.

### DETAILED DESCRIPTION

The technology described herein relates generally to a system and method for forming a non-circular checkerboard cake 10. Any non-circular cake is contemplated as long as the cake has a length L and a width W.

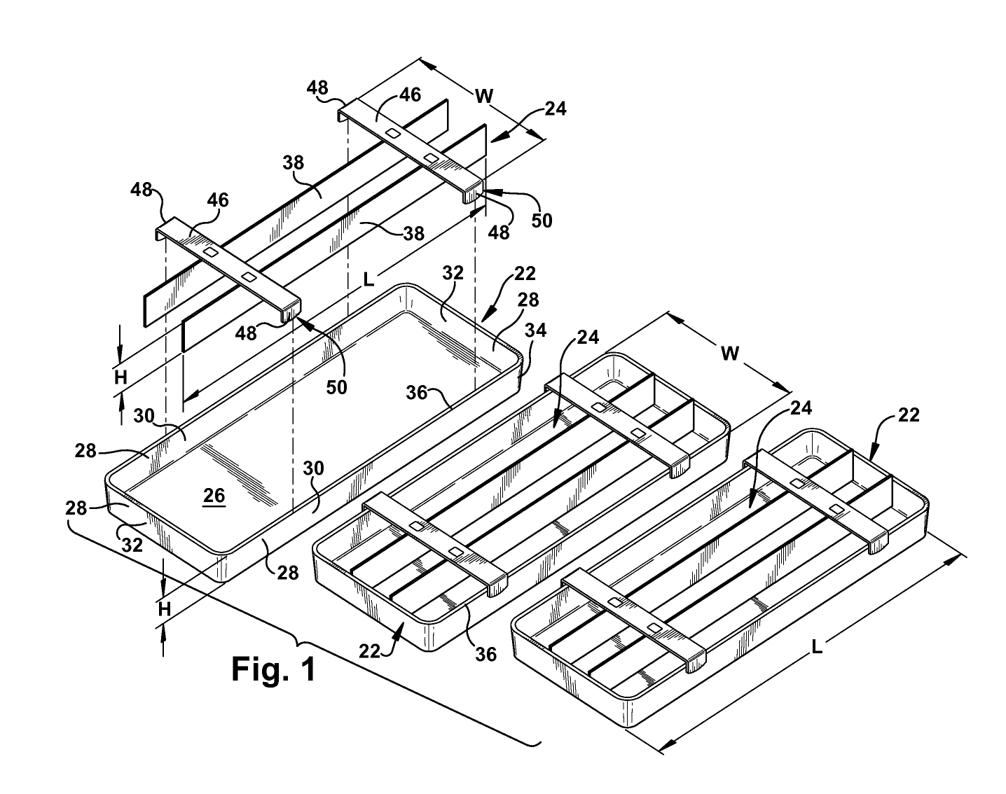

Referring to FIG. 1, an example system 20 for forming a rectangular checkerboard cake 10 is shown. By way of example, the system 20 includes three rectangular baking pans 22 and an insert 24. Three inserts 24 are shown for exemplary purposes. However, the system my only include one or two inserts 24, if desired, or fewer pans 22. The pans 22 are the same shape and size, although they could alternatively be different shapes and sizes, as long as the pans 22 can be used together to form a cake. It should be noted that while the drawings and the discussion below are in the context of a rectangular cake, other shapes may also be utilized with equal success.

The baking pan 22 has a bottom wall 26 and upstanding side walls 28. The side walls 28 extend along the sides 30 and the ends 32 of the pan 22 in a contiguous manner in order to form a receptacle 34 for receiving cake batter (not shown). The pan 22 has a length L and a width W. In this case, since the pan 22 is rectangular, the length L is greater than the width W. The pan 22 may have rounded edges 35, as shown, or other edges. The shape of the pan 22 is not critical to the invention other than it should have a length L and a width W and, thus, not be circular.

Three pans 22 may be provided in order to bake a three layer 12, 14, 16 checkerboard cake 10, as shown in FIG. 3. More or less layers may also be utilized. For example, a single pan 22 could be provided with a single insert 24, in which case the consumer would need to bake one layer 12, 14, 16 at a time. If two or three pans 22 are provided, then two or three layers 12, 14, 16 can be baked at a single time in the same oven, depending upon the size of the oven and the size of the pans 22. The side walls 28 of the pan 22 include a top edge 36 which serves as a rim. The rim 36 may be a turned over piece of material, or any known type of rim. The pan 22 may be metal, silicon, plastic, or other known materials that can be used for baking purposes, either in an oven or in a microwave. To the extent that the term oven is utilized herein, it is meant to encompass any type of oven, including a conventional oven and a microwave oven.

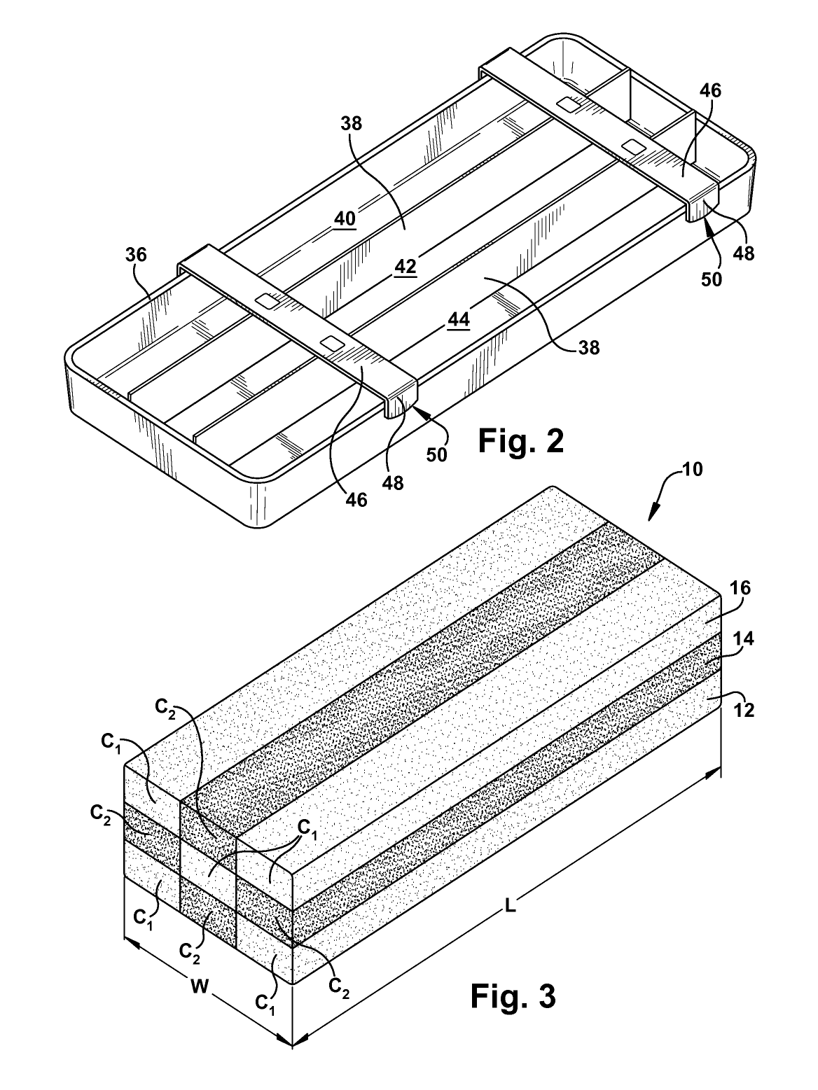

The insert 24, shown in FIGS. 1 and 2, includes two dividing members 38 which are positioned inside the pan 22. The dividing members 38 extend longitudinally and together with the pan 22 form three separate channels 40, 42, 44. More than two dividing members 38 may also be utilized if more channels are desired. In addition, the dividing members 38 could alternatively extend width-wise instead of lengthwise. The insert 24 is insertable into and removable from the pan 22. The insert 24 is typically installed in the pan 22 before cake batter is poured into the pan 22 and then is gingerly removed from the pan 22 after the batter has been poured into the channels 40, 42, 44 in order to not stir up the cake batter during removal. Internal pressure within the liquid batter should prevent the batter from mixing after the insert 24 is removed.

The dividing members 38 are shown as substantially flat bars or strap that have a height H and length L. The flat surfaces of the bars are parallel to the sides 30 of the baking pan 22 and may have a height H that is greater than the height H of the side walls 28 so that at least part of the insert 24 extends slightly above the top rim 36 of the baking pan 22.

Cross-braces 46 are coupled to the dividing members 38 in order to maintain them in spaced relation and to stabilize the insert 24. The cross-braces 46 are shown extending width-wise across the baking pan 22 and are strap-like members that have substantially flat upper and lower surfaces. The flat surfaces of the straps 46 are parallel to the bottom wall 26 of the baking pan 22, when installed. Two cross-braces 46 are shown, but more could be utilized. The cross-braces 46 are fixedly coupled to the dividing members 38 in order to maintain the dividing members 38 in spaced relation. The cross-braces 46 may be evenly spaced along the length L of the baking pan 22, or may be non-evenly space. For example, as shown, the braces 46 are positioned closer to the ends 32 of the baking pan 22.

The cross-braces 46 extend perpendicular to the direction of the dividing members 38. When the dividing members 38 extend lengthwise, as shown, the cross-braces 46 extend width-wise. When the dividing members 38 extend width-wise, the cross-braces 46 extend length-wise. The cross-braces 46 may be coupled to the dividing members 38 in any known manner, including by welding, adhesive, clip, or any other know technique for joining materials. The insert may be metal, plastic, silicon, or any other material known to those of skill in the art. Since the insert and baking pan are in contact with food, it is preferred that they be food safe.

The cross-braces 46 may have a length L that is less than the corresponding width W of the pan 22 (or vice versa if the braces 46 extend lengthwise). Alternatively, as shown, the cross-braces 46 may have a length L that is greater than the width W of the pan 22 such that the ends 48 of the cross-brace 46 sit on top of the rim 36 of the baking pan 22. The ends 48 of the cross-braces 46 may also have wings 50 that bend downwardly at about a 90 degree angle to wrap around the side 30 of the pan 22. The wings 50 may be angled at another angle, such as at any angle between about 45 degrees and about 90 degrees, for example.

FIG. 3 shows a cake 10 after three layers 12, 14, 16 of rotating colored batter have been positioned on top of one another. As is evident, a checkerboard pattern is visible at the end of the cake 10. By providing more dividing members 38, a greater number of rows, defined by channels, can be created for the checkerboard. If a two color checker board is preferred, in the first 12 and third layers 16 of the cake 10, the user would put a first color C1 in the two outer channels 40, 44 and a second color C2 in the inner channel 42. For the second layer 14, the user would use the opposite, with the first color C1 being positioned in the center channel 42 and the second color C2 being positioned in the outer channels 40, 44.

Frosting may be used on the cake, such as between the layers and around the top, sides, and ends of the cake 10 (not shown). The frosting may be useful to help to stabilize the layers on top of one another, depending upon how firm and sticky the frosting is. Alternatively, the cake 10 can remain frosting free so that the checkerboard pattern is visible at all times instead of being obscured by frosting.

The method for forming a non-circular checkerboard cake 10 includes the following steps. First a baking pan 22, such as that described above, is provided. An insert 24 is positioned in the baking pan 22 and then batter is poured into the channels 40, 42, 44 that are formed by the insert 24 inside the baking pan 22. Preferably, a first color C1 is provided in the first channel 40, a second color C2 is provided in the second channel 42, and a third color C3 is provided in the third channel 44. The first C1 and third C3 colors may be the same, such as in the case of a two color checkerboard, shown in FIG. 3. Alternatively, all three colors C1, C2, C3 could be different from one another (not shown).

Once the batter is poured into the channels 40, 42, 44, the insert 24 may be removed by lifting vertically out of the pan 22. This will allow the batter in each channel 40, 42, 44 to flow toward the batter in an adjacent channel. Once the rows of batter meet, they should generally not mingle together in any appreciable manner. Once the insert 24 has been removed, the baking pan 22 is ready to be placed in an oven such that the batter can be cooked to form a first layer 12 of a cake 10.

A second layer 14 of cake 10 can be formed in the same manner. The insert 24 is inserted into a second baking pan 22 and the same steps, as identified above, are followed. If a two color checkerboard is desired, the first color C1 of batter would be positioned in the center channel 42 and the second color C2 of batter would be positioned in the side channels 40, 44. This second layer 14 may then also be baked. It can be baked simultaneously with the first layer 12 or separately. In addition, where only one cake pan 22 is available, the second layer 14 of cake 10 would be baked once the first 12 layer of cake 10 has been removed from the baking pan 22.

In a similar manner, the third layer 16 of cake 10 may be formed. The insert 24 is inserted into a third baking pan 22 and the same steps, as identified above, are followed. Where a two-color checkerboard is desired, the first color C1 is positioned in the first channel 40, the second color C2 is positioned in the center channel 42, and the third color C3 (which would be the same color as the first color C1) is positioned in the third channel 44. The batter is then baked to make the third layer 16. As above, if only one cake pan 22 is available, the third layer 16 of the cake 10 may be baked once the first and second layers 12, 14 are removed from the baking pan 22.

Once all three layers 12, 14, 16 are baked, the first, second, and third layers 12, 14, 16 are stacked on top of one another. Either the first 12 or third 16 layer may be positioned on the bottom. Then the second layer 14 is positioned in the middle and the remaining layer is positioned on top. This will provide the cake 10 shown in FIG. 3.

There may be times when more than two colors C1, C2 are preferred in a cake 10. For example, a child might prefer a multi-colored cake that has different colors in each of the layers (for a total of 9 colors), such as a rainbow cake, or where 3 or more colors are utilized. In practice, typically a user will mix up two different kinds of cake batter, so two colors C1, C2 will typically be utilized, but food coloring could be added in order to provide different colors with the same cake batter, if desired. Thus, any variation of colors may be utilized. In order to obtain a checkerboard pattern, it is desirable that the same colors are not placed in the same positions for side-by-side layers, although this is not critical to the invention.

Once the cake layers 12, 14, 16 are stacked on top of each other, frosting may be applied around the top and sides of the cake 10. Alternatively, frosting could be positioned between each layer and/or around the top and sides of the cake 10. Frosting is optional.

As discussed above, the baking pan 22 can be rectangular, square, triangular, a rhomboid, a parallelogram, an oval, or any novelty shape. Novelty shapes include characters, numbers, letters and other shapes as known by those of skill in the art. More or less dividers 38 may be utilized. In addition, any number of colors may be utilized for the batter, the invention not being limited to a particular color, to a particular orientation of the dividers, or to a particular number of dividers, cross-braces, or colors. Moreover, while the insert 24 is shown as resting on top of the baking pan 22 via braces 46, alternative techniques for inserting the dividers could also be utilized. For example, channels or other supports (not shown) could be defined in the walls 28 of the pan 22 for receiving the dividers 38, so that no cross-braces 46 are required.

A material other than cake batter may be utilized, if desired, such as brownie mix, Jell-O, or some other type of material. Thus, when the term “cake batter” is used herein in discussing the invention, it should be recognized that other materials may also be utilized with similar success.

One material that may be utilized for the baking pan 22 and insert 24 is carbon steel with a non-stick coating, as known by those of skill in the art. Also, while one insert 24 is shown, more than one insert 24 may be provided in a single kit, if desired.

The term “substantially,” if used herein, is a term of estimation.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

### LIST OF TERMS

10 non-circular checkerboard cake
20 system for forming a rectangular checkerboard cake
22 pan; L; W
24 insert
26 bottom wall of pan
28 side walls of pan; H
30 sides of pan
32 ends of pan
34 receptacle
35 rounded edges
36 top edge of pan/rim
38 dividing members H, L
40 first channel (side channel)
42 second channel (center channel)
44 third channel (side channel)
46 cross-braces L
48 ends of braces
50 wings of braces

What is claimed is:

1. A checkerboard baking pan system comprising:
at least one pan having a substantially flat bottom wall and upstanding side walls surrounding the bottom wall to form a receptacle, said at least one pan having a non-circular shape, with said non-circular shape having a length and a width; and
an insert for seating inside the at least one pan, said insert comprising:
at least two dividing members, and
means for supporting the dividing members to define channels within the pan between the dividing members.

2. The system of claim 1, wherein the means for supporting the dividing members comprises at least two cross-braces for coupling the dividing members together.

3. The system of claim 3, wherein the cross-braces are evenly spaced along a length or width of the at least two dividing members and extend width-wise.

4. The system of claim 1, wherein the at least two dividing members extending one of longitudinally or widthwise in the at least one pan.

5. The system of claim 2, wherein the cross-braces have a width or length that is greater than a respective length or width of the receptacle.

6. The system of claim 2, wherein the cross-braces include wings at the ends thereof, said wings extending downwardly at an angle relative to a top surface of the cross-braces such that the wings fold over the edge of the at least one pan.

7. The system of claim 1, wherein the dividing members are longitudinally extending bars that extend along the entire length of the receptacle.

8. The system of claim 7, wherein the longitudinally extending bars are evenly spaced across the width of the receptacle.

9. The system of claim 2, wherein the cross-braces are fixedly coupled to the at least one dividing members.

10. The system of claim 1, wherein the dividing members are substantially flat bars that have a height and vertical surfaces, with the vertical surfaces of the bars being oriented either parallel or perpendicular to the side walls of the at least one pan.

11. The system of claim 2, wherein the cross-braces are straps having a substantially flat upper and lower surface, with the upper and lower surfaces being substantially parallel to the bottom wall of the at least one pan.

12. The system of claim 1, wherein the dividing members have a height that is greater than a height of the side walls of the at least one pan.

13. The system of claim 1, wherein the insert defines three longitudinally extending channels in the at least one pan.

14. The system of claim 1, wherein the insert is removable from the at least one pan.

15. The system of claim 1, wherein the at least one pan is rectangular, square, triangular, a parallelogram, a rhomboid, or an oval.

16. The system of claim 1, wherein the at least one pan has a novelty shape.

17. The system of claim 2, wherein the at least one pan has a rim and the at least two cross-braces seat on top of the rim.

18. A method for forming a non-circular checkerboard cake having multi-layers, said method comprising:
1) providing at least one non-circular baking pan having a length and a width;
2) providing at least one insert having at least two dividing members;
3) inserting the insert into the at least one baking pan, with the at least two dividing members defining at least first, second and third channels in the baking pan;
4) pouring batter into the baking pan using a first color of batter for the first channel of the insert, a second color of batter for the second channel of the insert, and a third color of batter for the third channel of the insert;
5) removing the insert from the pan;
6) baking the batter in the pan until it is firm to form a first cake layer;
7) repeating the above steps either simultaneously or in succession for at least a second layer by using a color other than the first color in the first channel of the baking pan, a color other than the second color in the second channel of the baking pan, and a color other than the third color in the third channel of the baking pan;
8) removing the cake layers from the pans and stacking them one on top of each other to form a cake.

19. The method of claim 18, further comprising repeating steps 1 through 6 to form a third cake layer using a color that is different from the color of the batter in the first channel of the second layer, a color that is different from the color of the batter in the second channel of the second layer, and a color that is different from the color of the batter in the third channel of the second layer,
removing the third cake layer from the pan and stacking the first, second and third layers on top of each other, with the first layer being positioned on the bottom, the second layer being positioned in the middle, and the third layer being positioned on top to form the cake.

20. The method of claim 18, further comprising spreading icing between the layers and on the top and sides of the cake.
